(19) United States
(12) Patent Application Publication
(10) Pub. No.: US 2008/0169639 A1
(43) Pub. Date: Jul. 17, 2008

(54) Security Document Comprising A Light Source And Light-Processing Device

(75) Inventor: Martin Eichenberger, Zollikon (CH)

Correspondence Address: LADAS & PARRY LLP, 26 WEST 61ST STREET, NEW YORK, NY, 10023, US

(73) Assignee: Orell Fussli Sicherheitsdruck AG, Zuurich (CH)

(21) Appl. No.: 11/791,352

(22) PCT Filed: Nov. 23, 2005
(86) PCT No.: PCT/CH05/00690

§ 371 Date: Nov. 16, 2007

(30) Foreign Application Priority Data
Nov. 23, 2004 (CH) 1927/04

(51) Int. Cl. B42D 15/00

(52) U.S. Cl. 283/85

(57) ABSTRACT

A security document is provided with a light source and with a light-processing device, e.g. in the form of a hologram, which processes the light emitted by the light source by deflecting, reflecting, polarizing and/or partially absorbing it. The properties of the light source downstream of the light-processing device which are recognized by the tester or a test device as characteristic increase the security of the document.

The invention relates to a security document according to the preamble of claim 1.

Such security documents have a substrate, which is usually flexible, and on which there is arranged at least one security feature for the verification of the authenticity of the security document.

Volume or surface holograms or refractive gratings have, inter alia, been suggested as security feature in particular for bank notes or passports. Even though such features are hard to counterfeit, substantial means are invested in counterfeiting such documents, such that security can not be absolute.

Hence, it is an object to provide a security document of the type mentioned initially that further improves counterfeiting security.

This object is achieved by the security document according to claim 1. According to the invention, therefore, at least one light source is provided on the security document, as well as a light processing device, which processes the light from the light source by deflecting, reflecting, polarizing and/or partially absorbing it. Due to the characteristic properties of the light after the light processing device, which an examiner or a testing device can verify, the security is increased, because a counterfeiter would not only have to counterfeit the light source, but also the light processing device.

The term light source designates a device that is able to emit light in active manner (i.e. not only by mere reflection). For example, the light source can use one or more of the following technologies:
light emitting diodes, wherein organic as well as inorganic light emitting diodes can be used. Light emitting diodes are advantageous because of their compactness and low operating temperature.
Other electroluminescent materials, which can be caused to emit light by means of an electric current or an electric field.
Materials that can be caused to emit light by illumination with visible, infrared or ultraviolet light. This encompasses fluorescent or phosphorescent materials. Fluorescent materials can, for example, be excited to emit longer wavelength light by means of short wavelength light. Phosphorescent materials are characterized by the fact that there is a comparatively long time span between excitation and emission, such that they exhibit afterglow after an excitation. Optically nonlinear materials can also be used in the light source. Such materials are, inter alia, able to multiply the frequency of incoming light.

The light processing device can, for example, be a reflecting or transmitting diffractive structure, a lens structure, a surface or volume hologram, a waveguide, a mask or a combination of such devices.

Further preferred embodiments and applications are given in the following description with reference to the figures. These show

FIG. 1 a security document in the embodiment of a bank note,

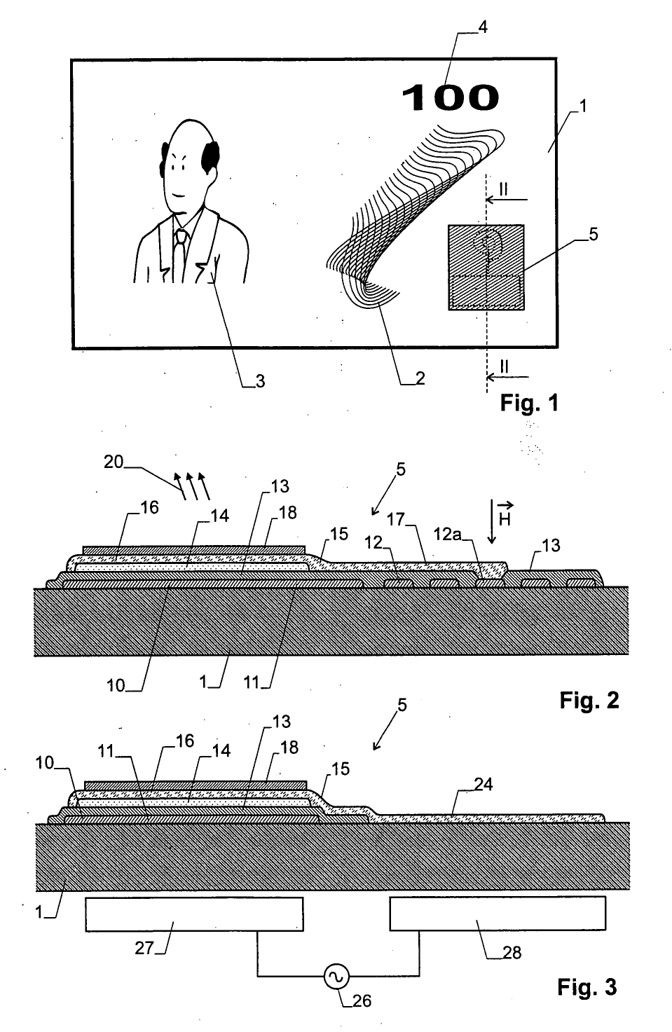

FIG. 2 a sectional view of an embodiment of the security feature with an electroluminescent light source with inductive supply and volume hologram,

FIG. 3 a sectional view of an embodiment of the security feature with an electroluminescent light source with capacitive supply and volume hologram,

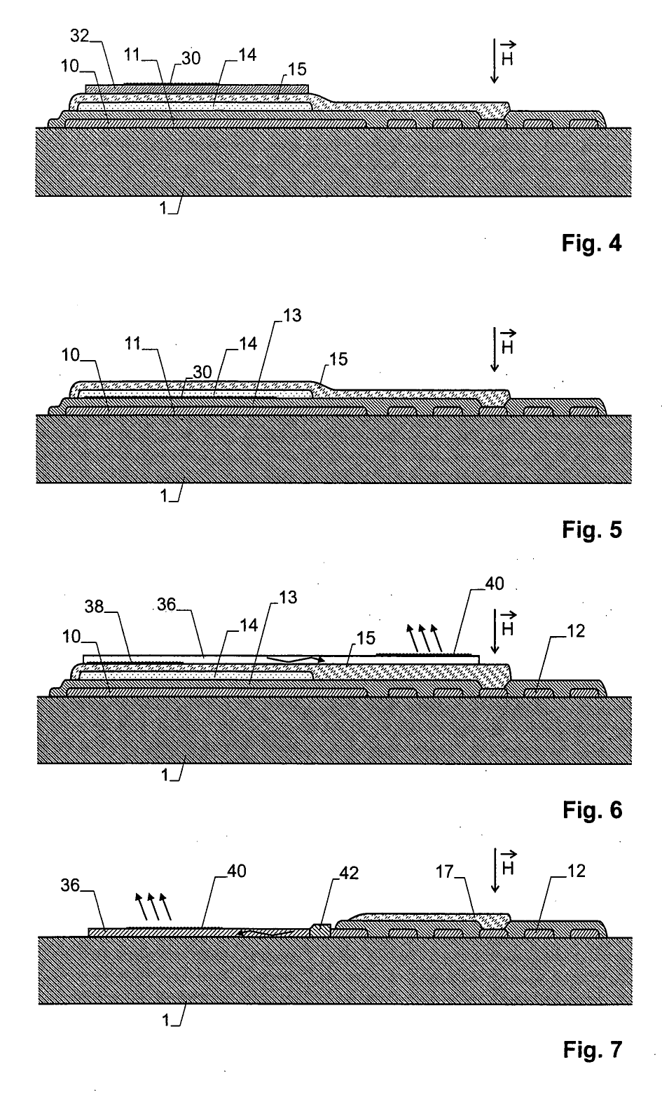

FIG. 4 a sectional view of an embodiment of the security feature with an electroluminescent light source with inductive supply and surface hologram,

FIG. 5 a sectional view of an embodiment of the security feature with an electroluminescent light source with inductive supply and reflective surface hologram,

FIG. 6 a sectional view of an embodiment of the security feature with an electroluminescent light source, inductive supply and waveguiding optics,

FIG. 7 a sectional view of an embodiment of the security feature with compact light source, inductive supply and waveguiding optics,

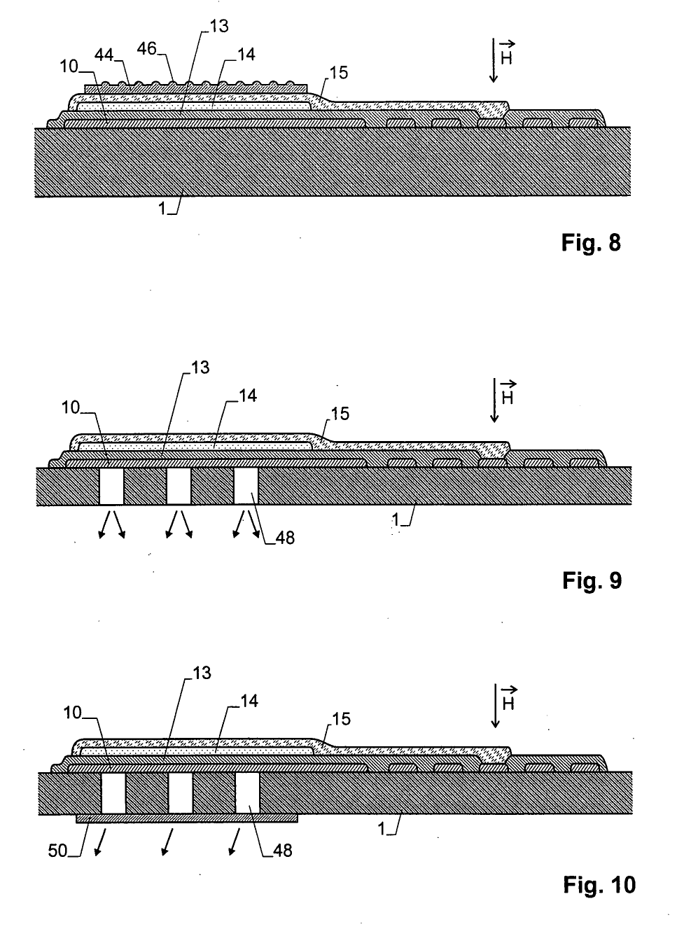

FIG. 8 a sectional view of an embodiment of the security feature with an electroluminescent light source, inductive supply and micro-lenses,

FIG. 9 a sectional view of an embodiment of the security feature with an electroluminescent light source, inductive supply and a hole mask,

FIG. 10 a sectional view of an embodiment of the security feature with an electroluminescent light source, inductive supply, hole mask and volume hologram,

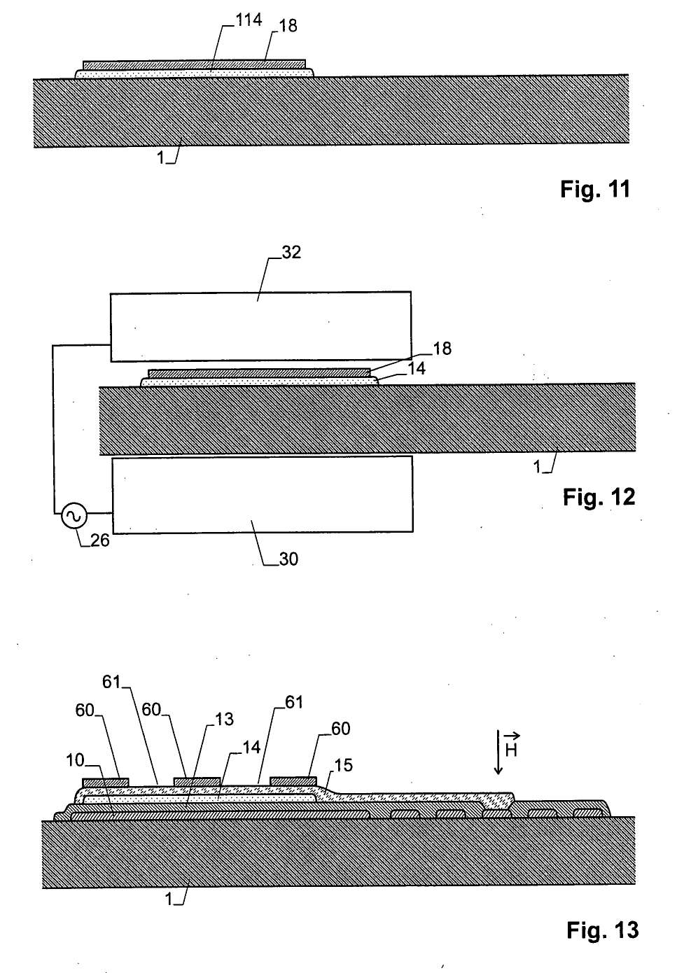

FIG. 11 a sectional view of an embodiment of the security feature with an fluorescent, phosphorescent, or nonlinear optical light source,

FIG. 12 a sectional view of an embodiment of the security feature with an electroluminescent light source, which is excited directly by an external field and

FIG. 13 a sectional view of an embodiment of the security feature with an electroluminescent light source, inductive supply and mask.

### BASIC SETUP

The basic setup of a security document in the example of a bank note is shown in FIG. 1. The security document comprises a flexible substrate 1 of paper or plastics, onto which graphical elements, for example in the shape of security designs 2, illustrations 3 and indications of value 4, are printed in known manner. In addition the bank note possesses a security feature 5, whose setup is first described as an example in the first embodiment according to FIG. 2.

FIG. 2 shows a sectional view along line II-II of FIG. 1. As can be seen, the security feature 5 is formed by a layer structure, which is advantageously applied to substrate 1 or to a carrier mounted to substrate 1 by printing techniques.

A lower conductive layer 10 consists of a conducting material and forms, on the one hand, an e.g. rectangular electrode 11 and a coil 12. On top of lower conductive layer 10 there is an insulating, dielectric layer 13. It covers the lower conductive layer 10 with the exception of a contact region 12a of the coil 12. On top of the dielectric layer 13 there is an electroluminescent layer 14 above the electrode, which is also substantially rectangular. A transparent, upper conductive layer 15 is placed on top of the electroluminescent layer 14. It forms an electrode 16 above the electroluminescent layer 14, as well as a conductive stripe 17, which is connected to the contact region 12a of coil 12. A volume hologram 18 is provided on top of the upper conductive layer 15 in the region of the electroluminescent layer 14. Suitable materiald and techniques for manufacturing the individual layers are described below.

The function of the security feature 5 is as follows: For verifying the feature, coil 12 is brought into or above a reading device, which generates a magnetic alternating field H̅, which induces a voltage 12 in the coil, which then lies over the electrodes 11 and 16 and generates a current in the electroluminescent layer 14 and exits the same to emit light. The light generated in this manner traverses the transparent upper electrode 16 and the volume hologram 18. The deflective structures in volume hologram 16 are arranged such that they deflect at least part of the light from the electroluminescent layer 14 and generate a characteristic illumination pattern 20, which can be examined by the examiner visually or by apparativ means.

In general the security feature 5 consists of a light source, such as the electroluminescent device of FIG. 2, and a light processing device, such as the volume hologram 18 of FIG. 2. Depending on the embodiment, the security feature 5 further requires a power supply, such as the coil 12 of FIG. 2. Possible embodiments of these components are discussed in the following.

Light Source:

The light source must be suited to be applied on the respective substrate 1 and to cooperate with the light processing device. It can be substantially monochrome or polychrome, which allows, as described below, to obtain characteristic effects in cooperation with the light processing device. The term “monochrome light” is understood such that the light appears to have a single color for the human observer even after decomposition into its colors, e.g. in a prism, while the term “polychrome light” is to be understood such that the light comprises spectral contributions that can be clearly distinguished by the color by a human observer after a color decomposition.

Various technologies can be used for the light source. Some particularly advantageous possibilities are:

Electroluminescent Materials

The phenomenon of electroluminescence describes, in general, the light emission of materials if the same are traversed by a current. In particular there are various sub-stances of which it is known that they emit light, for example when being arranged between two electrodes and a sufficient voltage is applied. Such materials can be used advantageously in the present application.

In particular the so called organic light emitting diodes (OLED or PLED) fall within this material class. They have the advantage that they can be manufactured flexibly. Suitable devices are e.g. described in U.S. Pat. No. 6,750,472.

Particularly preferred are materials which can be applied to the substrate by printing techniques. For example the company DuPont (Bristol, UK) offers a set of materials under the trademark “Luxprint”, which allows to manufacture suitable light sources by means of printing techniques. Electroluminescent materials that can be applied by printing techniques are termed herein as electroluminescent inks.

In the embodiment of FIG. 2, e.g. one of the light emitting substances 8150 (white), 8152 (blue-green), 8154 (yellow-green) or 8164 (bright yellow) can be used as electroluminescent layer 14 when the Luxprint materials are applied, depending under desired color of the emitted light. Suitable materials for the other layers can e.g. be found in the description “Processing Guide for DuPont Luxprint Electroluminescent Inks” from DuPont, version 1.0, 03/2002.

Conventional Light Emitting Diodes

Because of their low power consumption and their low operating temperature conventional light emitting diodes (LEDs) based on inorganic semiconductor materials are also particularly suited for the present application. When using a flexible substrate 1, however, only small light emitting diode devices should be used, such that these are not damaged when deforming the substrate. For illuminating larger areas several light emitting diode devices can be arranged in a matrix, for example by replacing the electroluminescent layer 14 in the embodiment of FIG. 2 by such a matrix. The upper conducting layer 15 is replaced by electrically conducting lines for feeding the LEDs.

An embodiment with only a single LED is described further below in reference to FIG. 6.

Fluorescent Materials

The light source can also be formed by fluorescent or phosphorescent materials, which emit light during or after suitable excitation.

Preferred are, in particular, materials that can be excited by illumination with light. Corresponding dyes are known to the person skilled in the art. A sectional view of a possible embodiment of a corresponding security feature is shown in FIG. 11. The light source is formed by a layer 114 with a fluorescent dye. The light processing device, e.g. a volume hologram 18, is provided on top of the layer 114.

For verifying the security feature of FIG. 11 the layer 114 is excited, e.g. by irradiation with e.g. UV-light. The light generated by the layer 114 is then deflected at least partially by the volume hologram, as in the first embodiment, and can be examined by an examiner.

Nonlinear-Optical Materials

Various organic or inorganic materials possess strong nonlinear-optical properties. Such materials are i.a. able to multiply the frequency of incoming light, wherein the strongest defects are observed for frequency doubling or tripling. Possible inorganic materials are e.g. LiNbO₃, KDP (KH₂PO₄) or KnbO₃. A wide spectrum of molecules with delocalized electron systems and donor- and acceptor groups is known in the organic field, which have strong non-optical properties, such as 2-methyl-4-nitroaniline (MNA), methyl-(2,4-dinitro-phenyl)-aminopropanoate (MAP) or urea. Corresponding light sources can e.g. comprise a powder of the corresponding material suspended in a polymer matrix or as side groups in a polymer matrix. In order to promote nonlinear-optical effects of second order, in particular when using organic materials, the nonlinear-optical molecules can be aligned by applying an electric field prior to hardening the matrix.

A nonlinear-optical light source of this type can e.g. be illuminated with a pulsed infrared laser, whereupon it emits frequency doubled light e.g. in the green spectral region.

A corresponding security feature of this type can again e.g. be designed as shown in FIG. 11, wherein the nonlinear-optical material is arranged in the layer 114.

Power Supply:

When using LEDs, OLEDs or electroluminescent light sources, suitable means must be provided to generate the required current in the light source.

In the following some examples for power supplies are presented.

Inductive Coupling

An inductive coupling of electric energy has already been used in the embodiment of FIG. 2. In order to be able to inductively couple voltage into the security feature, the same must have a coil with at least one winding of a conductive material. Preferably several windings are provided. The coil can be ranged beside the light source, as schematically shown in FIG. 1, but also e.g. below the light source or around the light source.

The coil and the capacitor formed by the light source form, in first approximation, an LC resonant circuit. If the light source requires a high voltage, the frequency of the magnetic alternating field H̅ should be placed close to the resonance of the resonant circuit.

Capacitive Coupling

Instead of the inductive coupling it is also possible to use a capacitive coupling. An embodiment of a corresponding security feature 5 is shown in FIG. 3. The light source in this embodiment is built substantially in the same manner as the one of the embodiment of FIG. 2 and has an electroluminescent layer 14 on a dielectric layer 13 and a lower electrically conductive layer 11. On top of the electroluminescent layer 14 there is a transparent, upper conductive layer 15. In contrast to the embodiment of FIG. 2, however, there is no coil. Rather the upper conductive layer 14 form an electrode 24, e.g. beside the light source.

For exciting the light source to emit light, a voltage is capacitively coupled in by means of electrodes 11 and 24. For this purpose, a schematically shown in FIG. 3, a testing device with a alternating voltage source 26 and two external electrodes 27, 28 can be used. The two external electrodes 27, 28 are arranged and shaped such, that each of then can be brought into the proximity of one of the electrodes 11 and 24, respectively, of the security feature. For example the substrate 1 can be brought onto the electrodes and be positioned such that the electrodes 27 and 11 as well as 28 and 24 each form a capacitor, through which an alternating current can flow into the security feature 5.

In this embodiment the layer 11 can also be dispensed with, in which case the electrode 27 forms a capacitor together with electrode 16.

Direct Field Coupling

It is also possible to bring the electroluminescent layer 14 directly into an external electric alternating field. This is illustrated in FIG. 12. The feature shown here requires, in particular, no electrodes, but merely an electroluminescent layer 14.

Here, the testing device has two electrode plates 30, 32, at least one of which, e.g. electrode plate 32, is transparent. At least that region of the security document that caries the electroluminescent layer 14 is brought between the electrodes 30, 32, whereupon an alternating voltage is applied to the electrodes 30, 32. This voltage generates a field, which extends through the layer of the electroluminescent material and causes the same to emit light. The optical effects that are generated by the light processing device can e.g. be observed directly through the at least one transparent electrode plate 32.

Direct Electrical Contact

It is also possible to apply conductive electric electrodes forming electrical contact pads to the substrate.

Light Processing Device:

The light processing device serves to deflect, reflect, polarize or partially absorb the light from the light source. It can be designed in various manner. Its purpose is i.a. to offer the examiner a further means to verify the authenticity of the security document. In particular it should be designed such that it conveys certain characteristica to the light from the light source that can be easily verified by the eye/or by suitable apparatus.

Advantageous embodiments of the light processing device, which can be used individually or in combination, are described in the following.

Volume Holograms

In a preferred embodiment the light processing device comprises one or more volume holograms, as it has already been described in reference to FIG. 2. Volume holograms are understood to be holograms whose thickness is sub-stantially larger than a light wavelength such that the defractive effects are only visible under the respective Bragg-angle.

Suitable materials and techniques for generating volume holograms are e.g. known from EP 1 091 267 and WO 03/036389.

If the volume hologram is arranged over the light source, it should be a transmission volume hologram, which is able to deflect light incident from one side in such a manner that it still exits through the opposite side (in the same manner as non-deflected light but in a different direction than non-deflected light). For this to be possible, the local grating planes of respective holograms should be approximately parallel or under a comparatively small angle to a vector perpendicular to the layer.

The volume hologram can e.g. be a homogeneous grating, which deflects light of a given wavelength in a given direction. In this case the security feature 5 can be examined by verifying if a corresponding light reflex can be observed under the give direction. If the light source is polychrome, a characteristical, more or less clear rainbow effect can be observed under the given direction.

The volume hologram can however also have a complicated grating structure and e.g. represent a three-dimensional object.

In addition to the transmission-volume-hologram the light processing device can also comprise a reflection hologram, which can be written into the same layer as the transmission hologram or into a separate layer. In this case the reflection volume hologram is visible under and environmental light, while the transmission volume hologram only becomes visible when the light source is switched on.

The volume hologram can also be arranged between the light source and the substrate 1. In this case, if the substrate 1 is not transparent, the volume hologram has to be designed as a reflection volume hologram.

Surface Holograms

In addition to or alternatively to the mentioned volume hologram the light processing device can also comprise a surface hologram 30, as it is shown in FIG. 4. A surface hologram is understood to be a deflective structure that has a thickness of no more than a few wavelengths such that deflections are generated also clearly outside the respective Bragg-conditions.

The surface hologram 30 can e.g. be generated in known manner by embossing on the surface of a layer 32.

If the surface hologram 30 is arranged over the light source, the layer 32 must be transparent.

The surface hologram 30 can also be embossed directly on layer 15, wherein in this case the layer 32 can be dispensed with.

The surface hologram 30 can, as shown in FIG. 5, also be arranged below the light source or electroluminescent layer 14. In this case it does not have to be arranged on a transparent layer, because it should reflect light upwards into the layer 14.

Waveguides

The light processing device can also comprise a waveguide, which is a transparent device that is, in at least one direction, substantially longer than it is thick, wherein it is able to conduct light along this direction due to total reflection.

A corresponding security feature is shown in FIG. 6. The waveguide 36 is formed by a transparent layer and is arranged partially on top of the light source or the electroluminescent layer 14. In order to be able to couple light into the waveguide, a grating structure 38 is provided in the region of the light source, e.g. in the form of a surface grating or a volume hologram. The grating structure 38 deflects a part of the light from the light source into the waveguide 36, such that the same propagates along the waveguide. The light can e.g. be observed at the front end of the waveguide. It is also possible to provide a second grating structure 40 or another light scattering structure that couples the light out, at a location remote from the light source.

Instead of grating structures other structures of the type described in WO 03/098280 can, for example, be used.

Using a waveguide is also particularly advantageous in combination with a compact light source, such as an inorganic LED. This is illustrated in FIG. 7, where a small LED 42 is used as a light source. The LED 42 is, as in the embodiment of FIG. 2, fed with current from a coil 12.

The light from the LED 42 exits laterally in the embodiment of FIG. 7 and is directly coupled into the front end of a waveguide 36. For laterally coupling out the light from the waveguide 36, there is again provided a grating structure 14.

Other Light Defractive Structures

Instead of or in addition to holograms or waveguides, other structures that defract the light from the light source can be provided as light processing device.

FIG. 8 illustrates an embodiment where a transparent plate 44 with a plurality of microlenses 46 is arranged on the electroluminescent layer 14. The microlensees change the directional distribution of the light exiting from light source 14, which can be observed by the examiner of by a testing device.

The plate 44 can e.g. also comprise a Fresnel-lens or other surface structures. This solution differs from a surface hologram in that the surface structures have, in particular in directions parallel to the surface, typical sizes or dimensions that are substantially larger than the wavelength of the light from the light source.

Instead of an extended, electroluminescent layer that emits light diffusely, a matrix of inorganic small LEDs or small OLEDs can also be used advantageously for illuminating the plate 44, wherein one microlens 46 is provided for each LED or OLED. Since, in this case, the light sources are, in first approximation, spots, it is possible to create a defined imaging optics in this way, which e.g. allows to focus the light of the LEDs on certain points or to project it in given directions.

Polarisers

The light processing device can also comprise one or more polarisers. For example the plate 44 of the embodiment of FIG. 8 can be replaced by a light polarizing foil.

In this case the light exiting from the security feature can be analyzed by means of a second polariser for verifying the authenticity.

Masks

The light processing device can also form a mask, which masks the light from the light source depending on location in more or less strong manner, be it by means of reflection or absorption. For example the mask can comprise a plurality of light-transmissive holes, through which the light from the light source can pass, and which otherwise block the light partially or completely.

Thus, the plate 44 of the embodiment of FIG. 8 can be replaced by a hole mask 60 with a plurality of holes 61, which generates a characteristic dot pattern for the observer. A corresponding embodiment is shown in FIG. 13.

Using a hole mask allows, for example, to generate a plurality of visually separated, non-continues light emitting areas at the locations of the holes 61, and this with only one structure for feeding the light source.

Using a mask allows, furthermore, to clearly structure the light emitting region, even if the light source itself is hard to structure. In particular at least one transparent opening can be provided in the mask, through which the light from the light source exits, wherein the opening is surrounding on all sides by non-light-transmissive material, i.e. by a material that transmits substantially less light than the opening. In this context the term “opening” is to be understood in the optical sense, i.e. it is a region that is optically transmissive, e.g. a hole in the mask or window.

In a preferred embodiment the openings of the mask represent a numeric or alphanumeric text, e.g. a number representing the bank note value or an abbreviation or a logo.

It is also possible to arrange a hole mask between the electroluminescent layer and the plate 44, namely such that one hole comes to lie under each microlens 46. Each microlens 46 processes light rom a substantially dot-shaped light source, which allows e.g. to focus the light at a given location or to project it in a given direction.

A particularly advantageous embodiment is shown in FIG. 9. Here the hole mask is formed by the substrate 1, by designing the substrate 1 to be light-transmissive at certain locations below the electroluminescent layer 14, e.g. by means of perforations 48. Corresponding techniques for the laser perforation of substrates 48 are e.g. described in WO 97/18092 and WO 04/011274.

For the light to be able to pass through the perforations 48, the layers 10 and 13 arranged below the electroluminescent layer 14 must be transparent.

In the embodiment shown in FIG. 9 the security feature can be verified by making the light source emit light and then by observing the document from the side opposite to the light source for examining if the light passes trough the perforations 48.

The light exiting from the perforations 48 can also be guided through further parts of the light processing device. In particular, as shown in FIG. 10, a hologram layer 50 can be provided at the exit of the perforations 48, or another structure for a defined deflection of the exiting light. The combination of such a structure with the perforations 48 is particularly advantageous because the light exiting from the perforations 48 as a better defined directional distribution than the light that directly originates from the diffusely light emitting electroluminescent layer 14, which allows more efficient deflection or projection in a hologram or a lens.

Preferably the perforations or light transmitting holes are therefore comparatively small and possess a diameter of no more than e.g. 100 μm.

In the embodiments described so far the mask consists of an absorbing or reflecting layer, in which perforations have been provided. It can however also consist of a layer without perforations, which is transparent in the regions of the “holes” and otherwise e.g. printed over with light absorbing ink.

Applications:

In principle the security feature of the invention is suited for all security documents, such as bank notes or other papers of value, passports or other identification documents, deeds etc. The security features shown here, which are assembled in layers, are in particular also suited for security documents with a flexible substrate 1, also for substrates of paper or plastics.

Remarks:

In the embodiments according to the figures the security feature 5 has been applied, as mentioned, directly to the substrate 1, e.g. by means of printing techniques. It is, however, also possible to apply the security feature 5 onto a carrier separate from substrate 1, and to pre-manufacture it in this way, such that the security feature 5 can be applied in one step as a whole onto the substrate 1. The manufacturing on a separate carrier has the advantage that manufacturing techniques can be used, which may not be compatible with the substrate 1, such as spin coating or etching techniques.

In addition to the layers shown in the embodiments the security feature 5 can comprise further layers, in particular protective layers above and/or below the other layers, in order to protect the same from mechanical influences as well as noxious substances, such as oxygen or humidity.

In a further advantageous embodiment the substrate 1 can also be transparent, at least in the region of part of the security feature. In this case the light processing device can also be arranged at least partially in the substrate 1 or between the substrate and the light source. An example for such an embodiment is the document of FIG. 9 or 10.

The substrate 1 can e.g. also carry a reflection hologram or other reflecting structures on its surface below the light source, which form part of the light processing device.

1. A security document with a substrate and a security feature arranged on the substrate for verifying the authenticity of the security document, wherein the security feature comprises a light source, by means of which light can be emitted, and a light processing device for deflecting, reflecting, polarizing and/or partially absorbing the light from the light source.

2. Security document of claim 1, wherein the light source can be excited to emit light by means of electrical current.

3. Security document of claim 2, wherein the light source comprises an electroluminescent material, in particular an electroluminescent ink.

4. Device of claim 1, wherein the light source comprises at least one organic or inorganic light emitting diode.

5. Security document of claim 1, wherein the light source can be excited to emit light by irradiation with infrared, visible or ultraviolet light.

6. A security document with a substrate and a security feature arranged on the substrate for verifying the authenticity of the security document, wherein the security feature comprises
a light source, by means of which light can be emitted, and
a light processing device for deflecting, reflecting, polarizing and/or partially absorbing the light from the light source,
wherein the light source comprises a nonlinear-optical material.

7. Security document of claim 1, wherein the light source is monochrome.

8. Security document of claim 1, wherein the light source is polychrome.

9. Security document of claim 1, wherein it comprises means to generate an electrical current in the light source.

10. Security document of claim 9, wherein it comprises at least one coil in which the current can be generated inductively.

11. Security document of claim 1, wherein it comprises at least one electrode, by means of which the current can be generated capacitively.

12. Security document of claim 1, wherein the light processing device comprises a surface and/or volume hologram.

13. Security document of claim 12, wherein the light processing device comprises a transmission volume hologram.

14. A security document with a substrate and a security feature arranged on the substrate for verifying the authenticity of the security document wherein the security feature comprises
a light source, by means of which light can be emitted, and
a light processing device for deflecting, reflecting, polarizing and/or partially absorbing the light from the light source, wherein the light processing device comprises a surface transmission volume hologram and a reflection volume hologram.

15. Security document of claim 1, wherein the light processing device comprises a waveguide, and in particular that a deflective structure, in particular a grating structure, is arranged at the waveguide for laterally coupling the light in or out.

16. Security document of claim 1, wherein the light processing device comprises a surface structure with a typical size much larger than wavelength of the light from the light source, and in particular that the surface structure forms one or more lenses and/or one or more Fresnel-lenses.

17. Security document of claim 1, wherein the light processing device comprises a mask that blocks the light from the light source differently depending on location.

18. Security document of claim 17, wherein the mask comprises a plurality of light-transmissive holes, through which the light from the light source can pass, wherein the mask otherwise blocks the light partially or completely.

19. Security document of claim 17, wherein the mask comprises at least one light-transmissive opening, through which the light from the light source can exit, wherein the opening is limited on all sides by non-light-transmissive material.

20. Security document of claim 17, wherein the openings represent a written text.

21. Security document of claim 1, wherein the light processing device is formed at least partially by the substrate.

22. A security document with a substrate and a security feature arranged on the substrate for verifying the authenticity of the security document, wherein the security feature comprises
a light source, by means of which light can be emitted, and
a light processing device for deflecting, reflecting, polarizing and/or partially absorbing the light from the light source, wherein the light processing device comprises a mask having a plurality of light-transmissive holes, through which the light from the light source can pass, wherein the mask otherwise blocks the light partially or completely, and wherein the mask is formed by the substrate, and in particular that a perforation is provided in the substrate in a region of the light source.

23. Security document of claim 1, wherein the light processing device comprises polarizer for polarizing the light.

24. Security document of claim 1, wherein the substrate is flexible, and in particular that the substrate is of paper.

25. Security document of claim 1, wherein it is a bank note.

26. Security document claim 1, wherein the security feature has been applied to the substrate by printing techniques.

27. Security document claim 1, wherein characterized in that the security feature has been applied to a carrier by printing techniques and that the carrier is mounted to the substrate.

28. The security document of claim 22, wherein a perforation is provided in the substrate in a region of the light source
